(19) United States
(12) Patent Application Publication
(10) Pub. No.: US 2010/0123637 A1
(43) Pub. Date: May 20, 2010

(54) ANTENNA

(75) Inventors: Chih-Jen CHENG, Taipei City (TW); Sheng-Mou HUANG, Yuanlin Township (TW)

Correspondence Address: Workman Nydegger;1000 Eagle Gate Tower, 60 East South Temple, Salt Lake City, UT, 84111, US

(73) Assignee: SMARTANT TELECOM CO., LTD., Jhudong Township (TW)

(21) Appl. No.: 12/271,285

(22) Filed: Nov. 14, 2008

(51) Int. Cl. H01Q 21/12

(52) U.S. Cl. 343/812

(57) ABSTRACT

An antenna includes a substrate, a signal feed portion, and a plurality of radiation units. The substrate has a first surface and a second surface. The signal feed portion is located on the substrate. The plurality of radiation units is located on the substrate, connected to the signal feed portion, and arranged in a radial shape. Each of the radiation units includes a radiation portion and a ground portion. The radiation portion is located on the first surface with one end connected to the signal feed portion. The ground portion is located on the second surface in symmetry with the radiation portion, with one end connected to the signal feed portion. A plurality of dipole antennas connected in parallel to the signal feed portion, so as to avoid a zero point generated on the single dipole antenna, such that a wave width of the antenna radiation has a large angle.

### BACKGROUND OF THE INVENTION

1. Field of Invention

The present invention relates to an antenna, and more particularly to an antenna with dipole antennas connected in parallel thereto.

2. Related Art

Since the wireless communication technology that uses electromagnetic waves to transmit signals can achieve the effect of communicating with a remote device without a connection by wires in use, the products employing the wireless communication technology, such as mobile phones and notebooks, are increasingly diversified. Since these products use electromagnetic waves to transmit signals, antennas for receiving/transmitting the electromagnetic wave signals become indispensable. Currently, the antennas are mainly divided into antennas exposed outside a device and antennas built in the device. However, the antenna exposed outside the device not only influences the volume, size, and beauty of the product, but also tends to be bent and broken due to external force impacts. Therefore, the built-in antenna has become a trend.

The antenna applied to a bridge node of a wireless local area network in an early period is mainly a dipole antenna or a monopole antenna, but the dipole antenna and the monopole antenna are complex in manufacturing and require high costs and expenses. Therefore, currently the manufacturing of the dipole antenna in a printed circuit board (PCB) manner is favored by manufacturers and has the advantages of easy manufacturing and low cost. The printed dipole antenna is achieved by manufacturing the dipole antenna on a PCB, and thus can be combined with the circuit wiring on the PCB in manufacturing, which not only omits multi-process complex steps to save the cost, but also reduces the volume of the product.

In the past, when a single dipole antenna is manufactured on a small substrate, a zero point may occur on a radiation pattern thereof in a pointing direction, such that when the single dipole antenna radiates signals, abnormal signal attenuation occurs at a certain angle in the antenna radiation scope.

### SUMMARY OF THE INVENTION

In view of the above problems, the present invention is directed to an antenna with at least one dipole antenna connected in parallel thereto. The at least one dipole antenna is connected in parallel to a signal feed point of a single dipole antenna, so as to alleviate the disadvantage that a zero point may be generated on the single dipole antenna.

The antenna disclosed according to the present invention includes a substrate, a signal feed portion, and a plurality of radiation units. The substrate has a first surface and a second surface. The signal feed portion is located on the substrate to feed in or feed out a signal. The plurality of radiation units is located on the substrate, connected to the signal feed portion, and arranged in a radial shape.

Each of the radiation units includes a radiation portion and a ground portion. The radiation portion is located on the first surface with one end connected to the signal feed portion. The ground portion is located on the second surface in symmetry with the radiation portion, with one end connected to the signal feed portion.

The antenna disclosed according to the present invention further includes a signal line and a base seat. The signal line includes a core, an insulating layer, and a ground layer. The core is connected to the radiation portion to transmit the signal. The insulating layer wraps the core. The ground layer wraps the insulating layer and is connected to the ground portion, so as to serve as a signal ground. The base seat is located at one side of the substrate and corresponds to the second surface, and includes a base plate and a frame. The base plate is located at one side of the substrate and corresponds to the second surface, and has a third surface corresponding to the second surface. The frame is disposed on the third surface and corresponds to and covers the plurality of radiation units.

The antenna disclosed according to the present invention has a plurality of dipole antennas connected in parallel to the signal feed portion, so as to alleviate the disadvantage that the zero point may be generated on the single dipole antenna and achieve the effect of a large half-power beam width angle. Meanwhile, the base seat is used to reflect signals radiated by the radiation units in a direction towards the second surface, i.e., to reflect and concentrate backward radiation of the antenna in a direction of forward radiation, so as to enhance a front-to-back ratio and suppress a side lobe.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a first embodiment of the present invention;

FIG. 2 is an exploded view of a second embodiment of the present invention;

FIG. 3 is a schematic assembled view of the second embodiment of the present invention;

FIG. 4 is an assembled side view of the second embodiment of the present invention;

FIG. 5 is a simulated diagram illustrating a radiation pattern at different angles at a frequency of 9.9 GHz according to the first embodiment of the present invention;

FIG. 6 is a simulated diagram illustrating a radiation pattern at different angles at the frequency of 9.9 GHz according to the second embodiment of the present invention; and

FIG. 7 is a diagram illustrating a radiation pattern measured at different angles at the frequency of 9.9 GHz according to the second embodiment of the present invention.

### DETAILED DESCRIPTION OF THE INVENTION

The features and implementations of the present invention are described below in detail with the accompanying drawings.

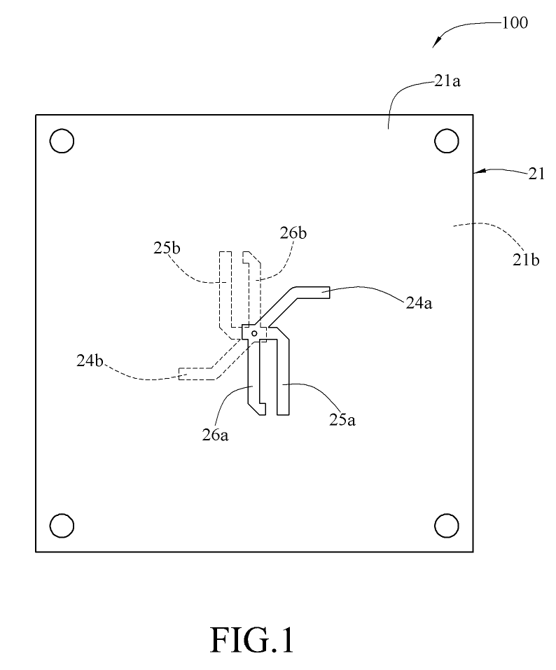

Referring to FIG. 1, a schematic view of a first embodiment of the present invention is shown. In this embodiment, an antenna 100 includes a substrate 21, a signal feed portion, and a plurality of radiation units.

The substrate 21 has a first surface 21a and a second surface 21b. The signal feed portion is located on the substrate 21 to feed in or feed out a signal. The plurality of radiation units is located on the substrate 21, connected to the signal feed portion, and arranged in a radial shape.

The plurality of radiation units includes a first radiation unit, a second radiation unit, and a third radiation unit.

The first radiation unit is located on the substrate 21, connected to the signal feed portion, and arranged in a radial shape. The first radiation unit includes a first radiation portion 24a and a first ground portion 24b. The first radiation portion 24a is located on the first surface 21a with one end connected to the signal feed portion. The first radiation portion 24a is in a geometric shape of a rectangle, a polygon, or the like. The first ground portion 24b is located on the second surface 21b in symmetry with the first radiation portion 24a, with one end connected to the signal feed portion.

The second radiation unit is located on the substrate 21, connected to the signal feed portion, and arranged in a radial shape. The second radiation unit includes a second radiation portion 25a and a second ground portion 25b. The second radiation portion 25a is located on the first surface 21a, with one end connected to the signal feed portion and the other end extended in a direction perpendicular to that of the other end of the first radiation portion 24a. The second radiation portion 25a is in a geometric shape of a rectangle, a polygon, or the like. The second ground portion 25b is located on the second surface 21b in symmetry with the second radiation portion 25a, with one end connected to the signal feed portion and the other end extended in a direction perpendicular to that of the other end of the first ground portion 24b.

The third radiation unit is located on the substrate 21, connected to the signal feed portion, and arranged in a radial shape. The third radiation unit includes a third radiation portion 26a and a third ground portion 26b. The third radiation portion 26a is located on the first surface 21a, with one end connected to the signal feed portion and the other end extended in a direction parallel to that of the other end of the second radiation portion 25a. The third radiation portion 26a is in a geometric shape of a rectangle, a polygon, or the like. The third ground portion 26b is located on the second surface 21b in symmetry with the third radiation portion 26a, with one end connected to the signal feed portion and the other end extended in a direction parallel to that of the other end of the second ground portion 25b.

In this embodiment, a plurality of dipole antennas is connected in parallel to the signal feed portion, so as to alleviate the disadvantage that a zero point may be generated on a single dipole antenna and achieve the effect of a large half-power beam width angle.

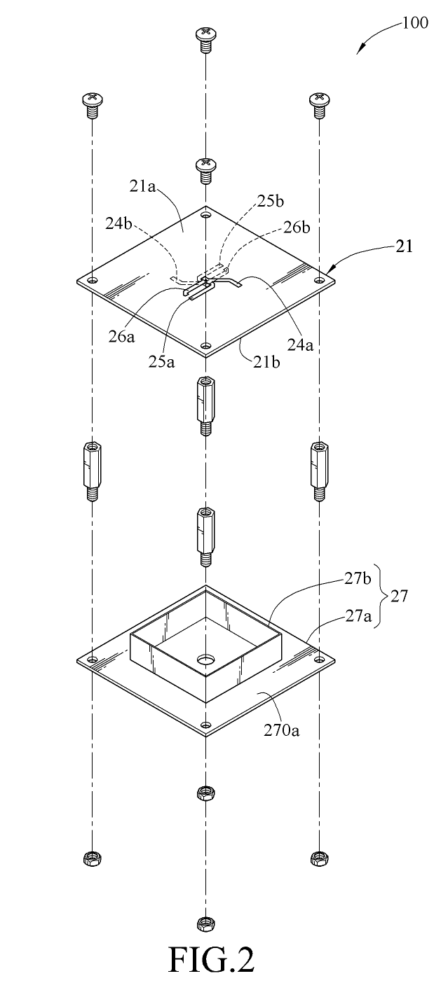

Referring to FIG. 2, an exploded view of a second embodiment of the present invention is shown. This embodiment is approximately the same as the first embodiment. In this embodiment, the antenna 100 includes a base seat 27. The base seat 27 is located at one side of the substrate 21 and corresponds to the second surface 21b, and includes a base plate 27a and a frame 27b. The base plate 27a is located at one side of the substrate 21 and corresponds to the second surface 21b, and has a third surface 270a corresponding to the second surface 21b. The frame 27b is disposed on the third surface and corresponds to and covers the first radiation unit, the second radiation unit, and the third radiation unit. The base plate 27a and the frame 27b are made of a metal material such as copper and aluminum. A signal line 23 may penetrate through the base plate 27a.

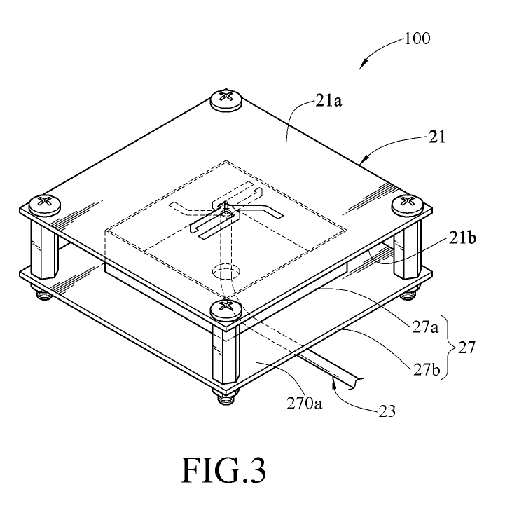

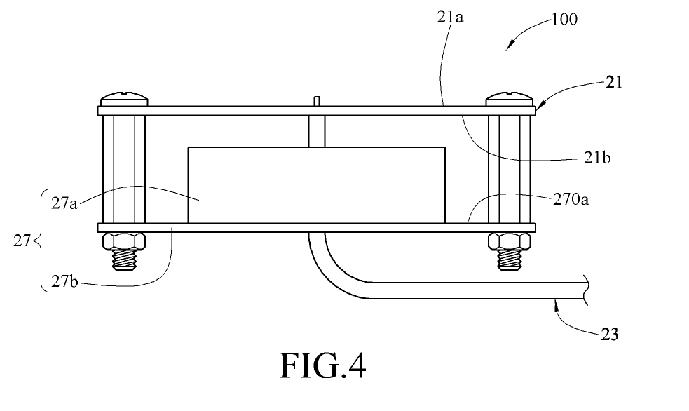

Referring to FIG. 3, a schematic assembled view of the second embodiment of the present invention is shown. The antenna 100 further includes the signal line 23. The signal line 23 includes a core, an insulating layer, and a ground layer. The core is electrically connected to the signal feed portion on the first surface 21a to transmit a signal. The insulating layer wraps the core. The ground layer wraps the insulating layer, and is electrically connected to the signal feed portion on the second surface 21b, so as to serve as a signal ground. The signal line 23 may penetrate through the base plate 27a. Referring to FIG. 4, an assembled side view of the second embodiment of the present invention is shown.

In this embodiment, the first radiation unit, the second radiation unit, and the third radiation unit are connected in parallel to the signal feed portion, so as to alleviate the disadvantage that a zero point may be generated on a single dipole antenna and achieve the effect of a large half-power beam width angle. Meanwhile, the base seat 27 is used to reflect signals radiated by the first radiation unit, the second radiation unit, and the third radiation unit in a direction towards the second surface 21b, i.e., to reflect and concentrate backward radiation of the antenna in a direction of forward radiation, so as to enhance a front-to-back ratio and suppress a side lobe.

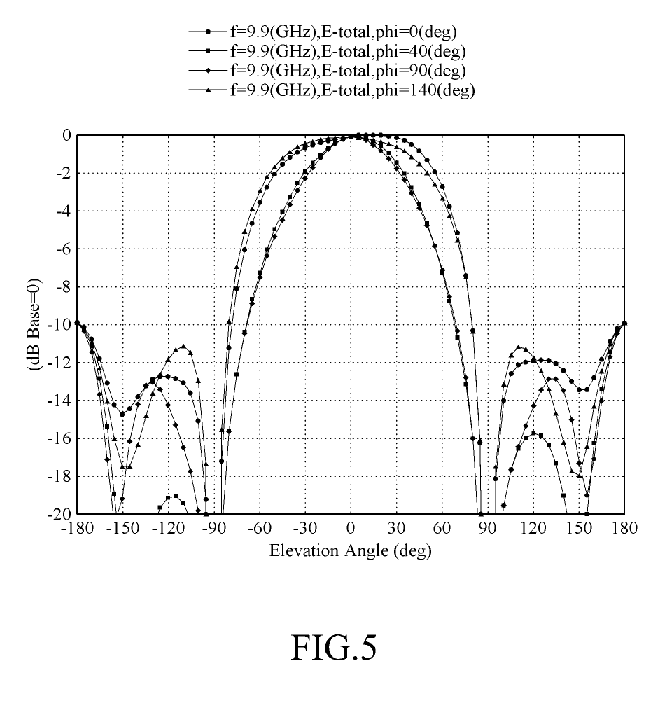

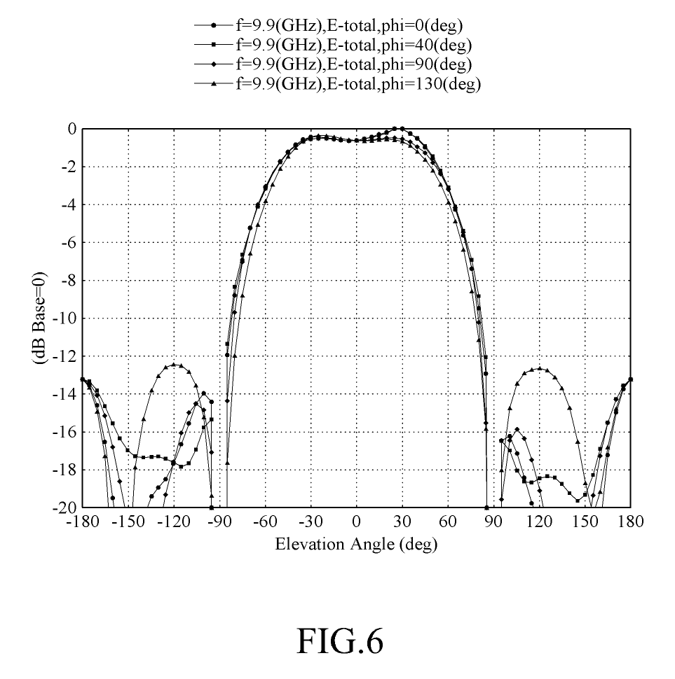

FIG. 5 is a simulated diagram illustrating a radiation pattern at different angles at a frequency of 9.9 GHz according to the first embodiment of the present invention, and FIG. 6 is a simulated diagram illustrating a radiation pattern at different angles at the frequency of 9.9 GHz according to the second embodiment of the present invention. As can be seen from FIGS. 5 and 6, the second embodiment of the present invention can obtain a larger radiation angle than the first embodiment of the present invention. Therefore, the antenna and the base seat disclosed in the present invention have the effect of increasing a half-power radiation angle.

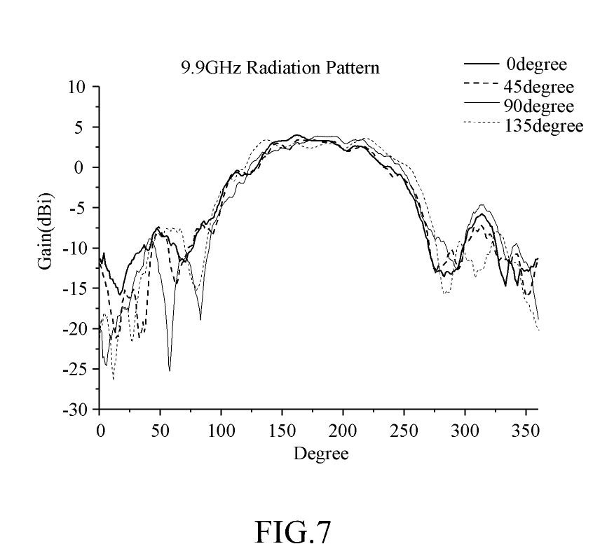

Referring to FIG. 7 and Table 1, FIG. 7 is a diagram illustrating a radiation pattern measured at different angles on a vertical plane at the frequency of 9.9 GHz according to the second embodiment of the present invention, and Table 1 is a table illustrating maximum gains and wave widths measured at different angles at the frequency of 9.9 GHz according to the second embodiment of the present invention.

TABLE 1
Table illustrating maximum gains and wave widths measured
at different angles at the frequency of 9.9 GHz

| Tangent plane (degree) | 0 | 45 | 90 | 135 |
|---|---|---|---|---|
| Maximum gain (dBi) | 3.98 | 3.41 | 3.86 | 3.61 |
| Wave width (degree) | 95.0 | 98.4 | 112.3 | 125.9 |

What is claimed is:

1. An antenna, comprising:
a substrate, having a first surface and a second surface;
a signal feed portion, located on the substrate to feed in or feed out a signal; and
a plurality of radiation units, located on the substrate, connected to the signal feed portion, and arranged in a radial shape, wherein each of the radiation units comprises:
a radiation portion, located on the first surface with one end connected to the signal feed portion; and
a ground portion, located on the second surface in symmetry with the radiation portion, with one end connected to the signal feed portion.

2. The antenna according to claim 1, wherein the radiation portion and the ground portion are symmetric in position.

3. The antenna according to claim 1, wherein the radiation portion and the ground portion are symmetric in shape.

4. The antenna according to claim 1, further comprising a signal line, wherein the signal line comprises:
a core, connected to the radiation portion to transmit the signal;
an insulating layer, wrapping the core; and
a ground layer, wrapping the insulating layer and connected to the ground portion, so as to serve as a signal ground.

5. The antenna according to claim 1, further comprising a base seat located at one side of the substrate and corresponding to the second surface.

6. The antenna according to claim 5, wherein the base seat comprises:
a base plate, located at one side of the substrate and corresponding to the second surface, and having a third surface corresponding to the second surface; and
a frame, disposed on the third surface, corresponding to and covering the plurality of radiation units.

7. The antenna according to claim 1, wherein the plurality of radiation units comprises:
a first radiation unit, located on the substrate, connected to the signal feed portion, and arranged in a radial shape, wherein the first radiation unit comprises:
a first radiation portion, located on the first surface with one end connected to the signal feed portion; and
a first ground portion, located on the second surface in symmetry with the first radiation portion, with one end connected to the signal feed portion; and
a second radiation unit, located on the substrate, connected to the signal feed portion, and arranged in a radial shape, wherein the second radiation unit comprises:
a second radiation portion, located on the first surface, with one end connected to the signal feed portion and the other end extended in a direction perpendicular to that of the other end of the first radiation portion; and
a second ground portion, located on the second surface in symmetry with the first radiation portion, with one end connected to the signal feed portion and the other end extended in a direction perpendicular to that of the other end of the first ground portion.

8. The antenna according to claim 7, wherein the plurality of radiation units further comprises:
a third radiation unit, located on the substrate, connected to the signal feed portion, and arranged in a radial shape, wherein the third radiation unit comprises:
a third radiation portion, located on the first surface, with one end connected to the signal feed portion and the other end extended in a direction parallel to that of the other end of the first radiation portion or the second radiation portion; and
a third ground portion, located on the second surface in symmetry with the third radiation portion, with one end connected to the signal feed portion and the other end extended in a direction parallel to that of the other end of the ground portion of the first radiation portion or the second radiation portion correspondingly parallel to the third radiation portion.
